(19) United States
(12) Patent Application Publication
(10) Pub. No.: US 2009/0165614 A1
(43) Pub. Date: Jul. 2, 2009

(54) METHOD AND A DEVICE FOR TRANSFERRING A TAIL

(75) Inventors: Rolf Petersson, Eneryda (SE); Mats Nyhlen, Löddeköpinge (SE)

Correspondence Address: NIXON & VANDERHYE, PC, 901 NORTH GLEBE ROAD, 11TH FLOOR, ARLINGTON, VA, 22203, US

(73) Assignee: ANDRITZ TECHNOLOGY AND ASSET MANAGEMENT GMBH, Graz (AT)

(21) Appl. No.: 12/294,089

(22) PCT Filed: Mar. 14, 2007
(86) PCT No.: PCT/SE2007/000242

§ 371 Date: Feb. 27, 2009

(30) Foreign Application Priority Data
Mar. 23, 2006 (SE) 0600652-2

(51) Int. Cl. B26D 3/00; B26D 7/06

(52) U.S. Cl. 83/44; 83/150

(57) ABSTRACT

A device for transferring a tail of a cellulose based fibrous web from a first unit to a second unit, the device includes: a separating member adapted to form a space between a first face of the tail and the first unit; a tail pick up pulley to be inserted in the space between the first face of the tail and the first unit, the tail pick up pulley moving the tail into a cutting position; a cutting device for cutting the tail at the cutting position, and a tail conveyor device for catching the tail cut at the cutting position and for forwarding the cut tail to the second unit.

### FIELD OF THE INVENTION

The present invention relates to a method of transferring a tail of a cellulose based fibrous web from a first treatment unit to a second treatment unit.

The present invention also relates to a device for transferring a tail of a cellulose based fibrous web from a first treatment unit to a second treatment unit.

### BACKGROUND OF THE INVENTION

When forming and drying a web-formed material, such as a cellulose pulp web, the web-formed material is treated in different units. For instance a cellulose pulp production plant may include a wet forming station, in which a slurry of for example cellulose fibres are treated to form a wet cellulose based fibrous web, and a pulp dryer in which the wet web is dried by means of blowing hot air towards the web. At start-ups, and when the web accidentally breaks, it is necessary to transfer the web from the wet forming station to the dryer. When transferring a web it is common to first form a narrow tail, also called a leader, at the wet forming station. The tail is then transferred to the dryer and passed into the dryer. When the tail has been successfully transferred to the dryer the tail may be gradually widened such that finally a web of full width is passed from the wet forming station to the dryer.

WO 02/088463 describes a method of transferring a tail from a first treatment step to a second treatment step. The method of WO 02/088463 includes moving the tail manually by means of displacing a roll in a horizontal direction or by means of lifting the tail by hand in order to get the tail in position for cutting it and subsequently feeding it into the second treatment step. It has been found, however, that the method of WO 02/088463 is not effective as regards how the tail is moved into position. The result is that transferring the web may is not always successful and that several attempts may have to be made until the transferring of the tail is successful. Further the method of WO 02/088463 also poses a safety hazard since the manual handling of the tail requires an operator to work dangerously close to the running web and often also close to running wires and rolls.

### SUMMARY OF THE INVENTION

An object of the present invention is to provide a method of transferring a tail from a first treatment unit to a second treatment unit, in which method the tail is moved into position for being introduced into the second treatment unit without exposing it to a tension which may break the tail. Another object is to transfer the tail in such a way that operators are not exposed to hazards.

These objects are achieved by a method of transferring a tail of a cellulose based fibrous web from a first treatment unit to a second treatment unit, the method being characterised in the following steps:

(A) forwarding the web from the first treatment unit, allowing the web to travel substantially vertically downwards from a first roll, and slitting the web along its longitudinal direction to form a tail having a first face facing the first treatment unit and a second face facing the second treatment unit,

(B) forming, by means of a separating member, a space between the first face of the tail and the first treatment unit,

(C) inserting a tail pick up pulley in said space between the first face of the tail and the first treatment unit, and moving, by means of the tail pick up pulley, the tail into a cutting position, and

(D) cutting the tail, and catching the tail by means of a tail conveyor device for forwarding the tail to the second treatment unit.

An advantage of this method is that it provides for a low tension in the tail when forwarding it from the first treatment unit to the second treatment unit. Since the tail is often comprised of a thin cellulose based fibrous web with a high water content the mechanical strength of the tail is very low. A tail typically has a width of about 100 mm and a thickness of 1.5 to 2.5 mm. Such a tail could typically stand a tensile force of maximum 50-120 N. The present invention provides for the very low tension in the tail that is required for safe and automatic transfer of a tail from the first treatment unit to the second treatment unit. Thus the tail may be transferred without necessitating manual interference, without exposing the tail to excessive tensions and with a large chance of being successful in each attempt to transfer the tail.

According to a preferred embodiment step (B) further comprises engaging the separating member with the first face of the tail and moving the tail, by means of the separating member, towards the second treatment unit. An advantage of this embodiment is that moving the tail generally requires less efforts than moving any other component when forming the space.

Preferably step (A) further comprises forwarding the web on a wire, the wire being moved away from the first face of the tail downstream of said first roll such that a gap is formed between the wire and the tail, and step (B) further comprises providing the separating member in said gap and widening said gap to form said space. An advantage of this measure is that the wire supports the web and decreases the risk that it is broken. Moving the wire away from the first face of the tail after the tail has passed the first roll is an efficient way of generating a gap, in which the separating member may be inserted, without exposing the tail to excessive tensions.

Preferably step (C) further comprises moving the tail pick up pulley both vertically upwards and horizontally towards the second treatment unit when moving the tail into the cutting position. By having the tail pick up pulley move the tail both vertically and horizontally the tail is more effectively moved into a suitable position for being cut and subsequently caught by the tail conveyor device.

Preferably step (B) further comprises moving the separating member in a horizontal direction while forming said space. An advantage of this embodiment is that the tail is moved in a way that does not expose it to an excessive tension. Further a horizontal movement is easy to control. Moving the separating member vertically upwards would expose the tail to a larger tension. Moving the separating member horizontally and vertically downwards at the same time is however possible. Still more preferably step (B) further comprises moving the separating member horizontally a distance of 200-800 mm while forming said space. An advantage of this embodiment is that a distance of more than 800 mm requires much room and is thus not suitable for practical reasons. A distance of less than 200 mm would make it difficult to insert a tail pick up pulley that has a sufficient diameter for keeping the tension in tail low while moving the tail into the cutting position.

Another object of the present invention is to provide a device adapted for safely transferring a tail from a first treatment unit to a second treatment unit in such a way that the tail is moved into position for being introduced into the second treatment unit without exposing the tail to a tension which may break it.

This object is achieved by a device for transferring a tail of a cellulose based fibrous web from a first treatment unit to a second treatment unit, the tail being formed by forwarding the web from the first treatment unit, allowing the web to travel substantially vertically downwards from a first roll, and slitting the web along its longitudinal direction to form a tail having a first face facing the first treatment unit and a second face facing the second treatment unit, the device being characterised in that it comprises

a separating member, which is adapted to form a space between the first face of the tail and the first treatment unit,

a tail pick up pulley which is adapted to be inserted in said space between the first face of the tail and the first treatment unit, the tail pick up pulley further being adapted for moving the tail into a cutting position,

a cutting device being adapted for cutting the tail at said cutting position, and

a tail conveyor device being adapted for catching the tail cut at the cutting position, and for forwarding the cut tail to the second treatment unit.

An advantage of this device is that it is adapted for transferring a tail with very little risk that the tail is broken. In particular the device is adapted for automatically transferring the tail from the first treatment unit to a second treatment unit.

According to a preferred embodiment the separating member is adapted to be inserted in a gap formed between the first face of the tail and a wire by which the web is forwarded, the gap being formed downstream of said first roll by the wire being moved away from the first face of the tail. Moving the wire away provides a simple yet safe way of providing a gap into which a separating member may be inserted, for to form said space.

Preferably the tail pick up pulley has a diameter of 120-400 mm, a motor being adapted for rotating the pulley. A diameter of at least 120 mm is preferable since it decreases the tension in the tail while moving the tail into the cutting position. A smaller diameter may result in breaking the tail over the tail pick up pulley. A diameter of more than 400 mm has the disadvantage that a very large space must be formed by the separating member in order to make it possible to insert the tail pick up pulley.

According to a preferred embodiment a guiding device is adapted for being located below the tail pick up pulley, when the tail is at the cutting position, in order to stabilize the tail when the tail cutting device cuts the tail. An advantage of the guiding device is that stabilizing the tail makes it easier to cut the tail correctly and to catch the cut tail by means of the tail conveyor device.

Preferably the separating member has a smallest dimension, such as a width or a diameter, which is 10-80 mm. A smallest dimension of less than 10 mm increases the risk that the tail is broken while using the separating member to form said space. A smallest dimension of more than 80 mm makes it more difficult to get the separating member in position, for instance in a gap between a wire and the tail.

Further objects and features of the present invention will be apparent from the description and the claims.

### BRIEF DESCRIPTION OF THE DRAWINGS

The invention will now be described in more detail with reference to the appended drawings in which:

FIG. 1 is a schematic side view and shows a first treatment unit, a second treatment unit and a device for transferring a tail.

FIG. 2a is a schematic side view showing the device for transferring a tail in more detail and in a first position.

FIG. 2b is a three-dimensional view showing specific details of the device for transferring a tail.

FIG. 2c is a schematic top view and illustrates, as seen from above, the device for transferring a tail in the position shown in FIG. 2a.

FIG. 2d is a schematic top view and illustrates how a separating pin has been introduced between a tail and the first treatment unit.

FIG. 3a is a schematic side view and illustrates how the separating pin has moved the tail.

FIG. 3b is a schematic top view and illustrates the situation of FIG. 3a as seen from above.

FIG. 4 is a schematic top view and illustrates how a tail pick up pulley has been inserted between the tail and the first treatment unit.

FIG. 5 is a schematic side view and illustrates how the pulley has lifted the tail.

FIG. 6a is a schematic side view and illustrates how the tail has been moved to a cutting position.

FIG. 6b is a schematic top view and illustrates the situation of FIG. 6a as seen from above.

FIG. 7 is a schematic top view and illustrates how a tail cutting device has been brought into position.

FIG. 8a is a schematic side view and illustrates how the tail has been cut and caught by a tail conveyor device forwarding it to the second treatment unit.

FIG. 8b is a schematic top view and illustrates the situation of FIG. 8a as seen from above.

FIG. 9 is an enlarged side view and illustrates a separating member according to an alternative embodiment.

### DESCRIPTION OF PREFERRED EMBODIMENTS

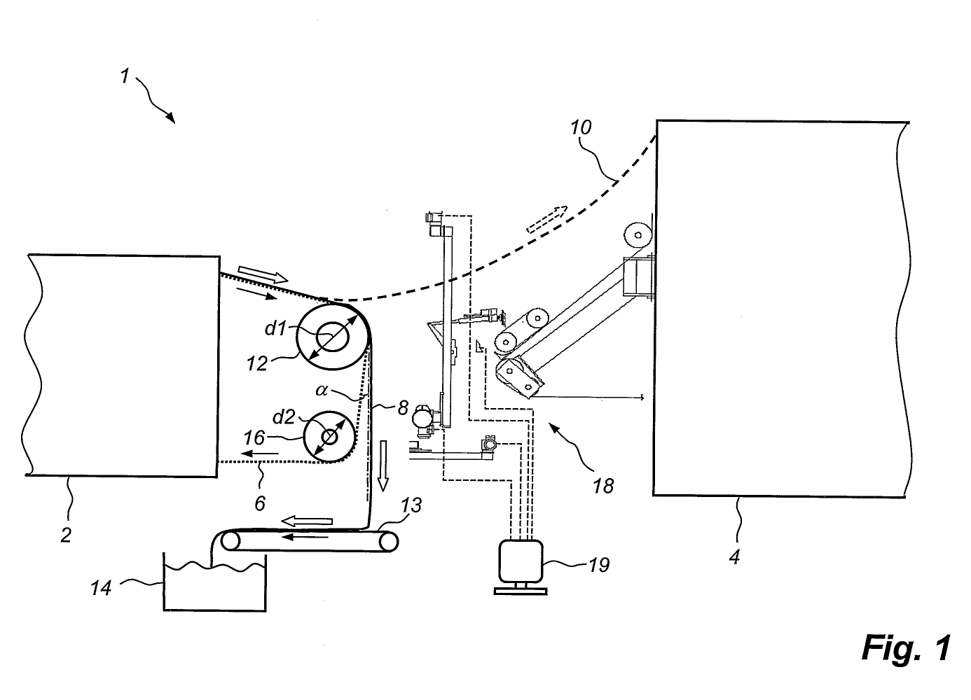

FIG. 1 shows a pulp production plant 1 adapted for production of market pulp, i.e. a pulp based on cellulose fibres obtained by pulping or bleaching. The pulp production plant 1 comprises a first treatment unit in the form of a wet forming station 2 and a second treatment unit in the form of a pulp web dryer 4. A slurry of cellulose fibres is fed to the wet forming station 2 from a not shown slurry tank. In the wet forming station 2 the slurry is, according to per se known principles, fed onto a forming wire, not shown, and is then forwarded to a press wire 6 and is then pressed between press rolls, not shown, to form a cellulose based fibrous web 8 being forwarded by the press wire 6. After the wet forming station 2 the web 8 has dry solids content of about 50%. The thickness of the web 8, just after the wet forming station 2, is about 1.5-2.5 mm. The web 8 has a width of typically 3-10 meters. The web is then supposed to be forwarded, indicated by a dashed web 10 in FIG. 1, to the pulp web dryer 4. In the dryer 4, which may be of the type Andritz Pulp Dryer, the web is dried by hot air to a dry solids content of typically about 90%.

In the situation shown in FIG. 1 the web 8 is not forwarded to the dryer 4. Instead the web 8 passes vertically downwards over a first roll 12 and onto a transport belt 13 by means of which the web 8 is transported to a repulper 14. In the repulper 14 the web 8 is dissolved in water and is then returned to the slurry tank.

The press wire 6 is also, as the web 8, passed over the first roll 12 and is then passed over a second roll 16 before being returned to the wet forming station 2. As can be seen the centre of the first roll 12 is located vertically above the centre of the second roll 16. The first roll 12 has a diameter d1 which is larger than a diameter d2 of the second roll 16. Thanks to this fact the press wire 6 will be moved towards the wet forming station 2 while travelling from the first roll 12 to the second roll 16, i.e. the press wire 6 will not travel vertically downwards from the first roll 12 but in an inclination α of about 7° from the vertical plane. As can be seen from FIG. 1 the web 8 will travel vertically downwards, due to its weight, and will therefore release from the press wire 6, which travels at the inclination α of about 7° from the vertical plane, just after having passed the first roll 12. In order to make it possible to automatically forward the web 8 from the wet forming station 2 to the dryer 4 a device 18 for transferring a tail of the web 8 from the wet forming station 2 to the dryer 4 is used. A process computer 19 controls the operation of the device 18, as is schematically illustrated in FIG. 1. The process computer 19 may also control the operation of the entire pulp production plant 1.

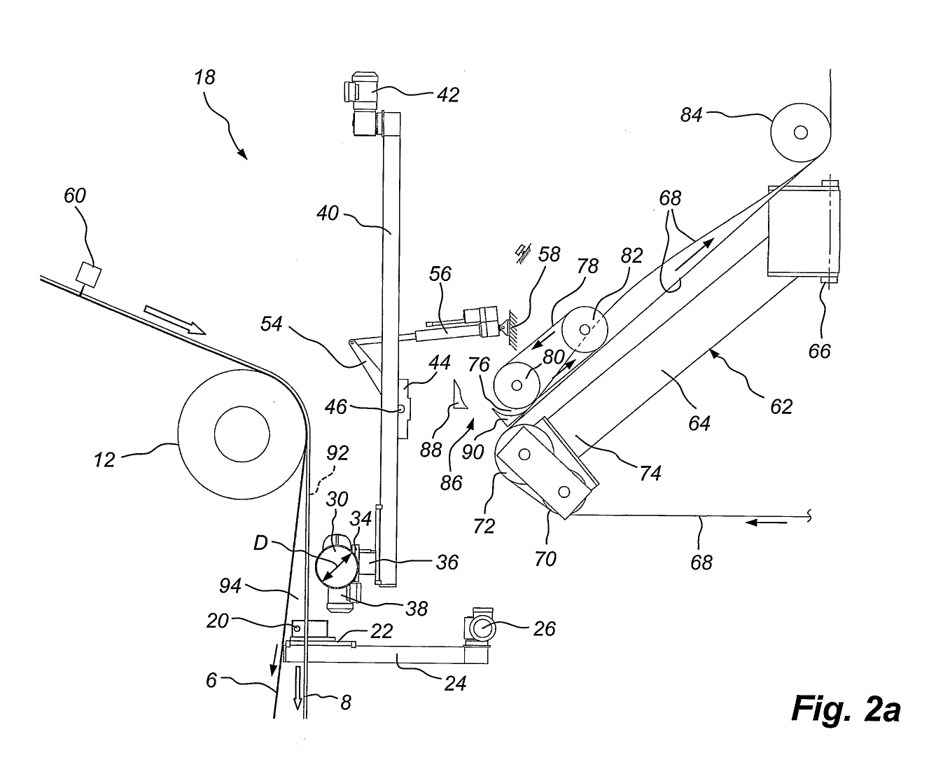

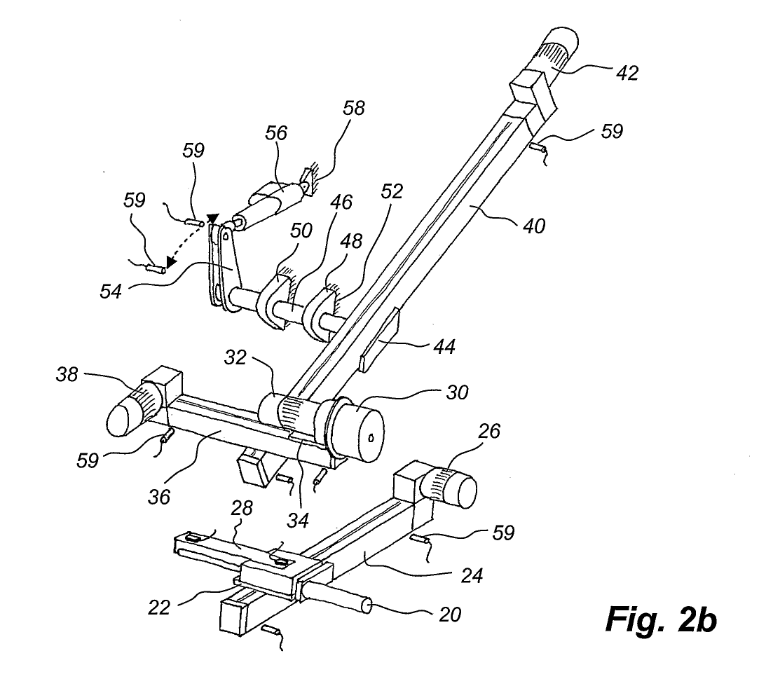

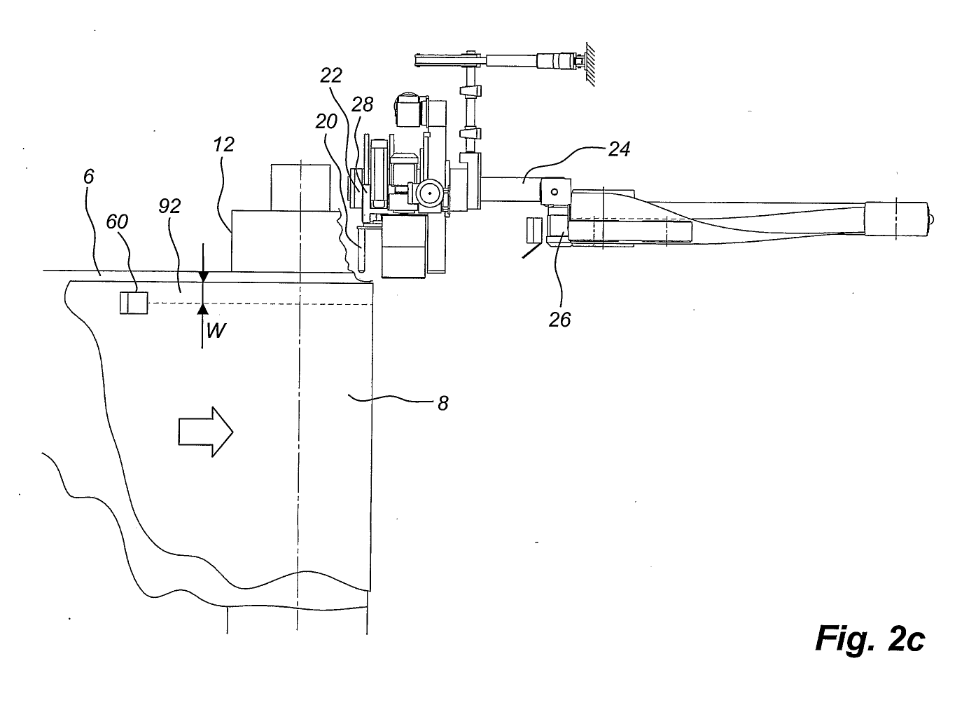

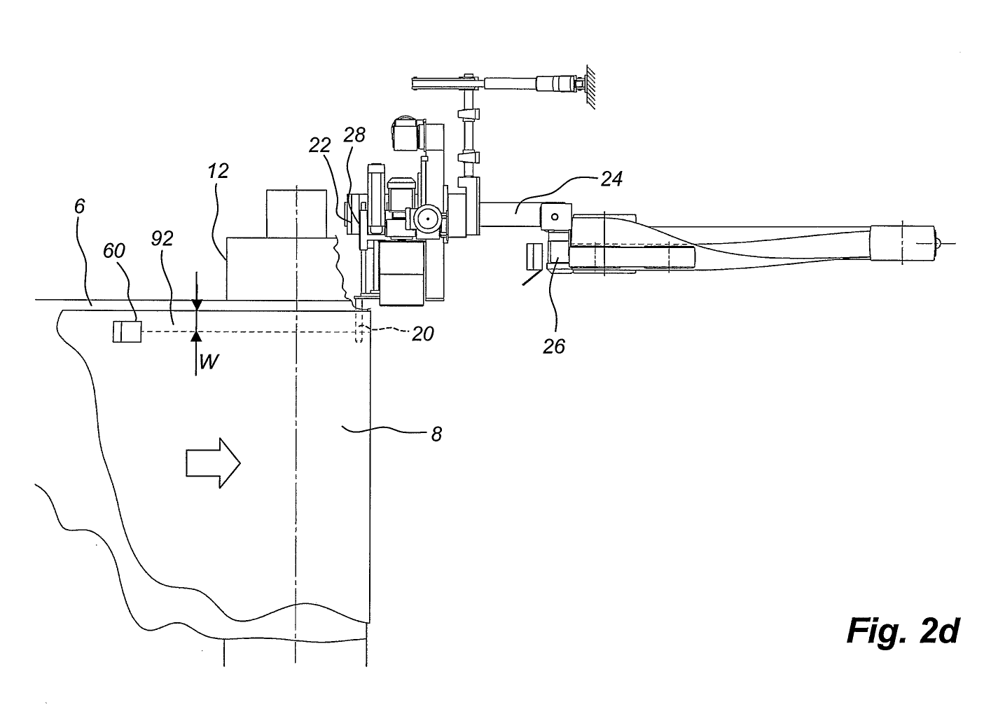

FIG. 2a illustrates the device 18 for transferring a tail in more detail. FIG. 2b is a three-dimensional illustration of some key components of the device 18.

It should first be mentioned that the prior art method of forwarding a web from a wet forming station to a dryer comprises forming a tail, also called a leader, of the web. The tail usually has a width of about 100 mm. The tail is manually lifted from the wet forming station to the dryer and is clamped in a folded threading tape, also called a threading belt. The threading belt forwards the tail through the dryer, which is usually referred to as threading the dryer. Typically about 25 meters of tail is introduced into the dryer. Then the tail is released from the threading belt at the entrance of the dryer and the width of the tail is gradually increased so that finally a web of full width travels through the dryer.

The present invention provides for an automatic method, and a device for carrying out the method, of transferring a tail from a first treatment unit, such as a wet forming station, to a second treatment unit, such as a dryer.

The device 18 comprises a separating member in the form of a cylindrical separating pin 20 which is attached to a sleigh 22. The sleigh 22, which is located below the roll 12, may be moved in a horizontal direction along a bar 24 by means of a motor 26. The sleigh 22 is provided with an air driven cylinder 28, which is shown in FIG. 2b, which makes it possible to move the separating pin 20 in its longitudinal direction, i.e. in a direction being perpendicular to the longitudinal direction of the bar 24. The separating pin 20 preferably has a diameter of about 10-80 mm.

Referring again to FIG. 2a the device 18 further comprises a tail pick up pulley 30. The tail pick up pulley 30, which has a diameter D of about 120 to 400 mm, may be rotated by means of drive motor 32, shown in FIG. 2b. The drive motor 32 is controlled so as to rotate the pulley 30 at suitable rpm with respect to the tail led over it, as will be shown later. The drive motor 32 is fixed on a sleigh 34, which is best shown in FIG. 2b. The sleigh 34 may be moved in a horizontal direction along a horizontal bar 36 by means of a horizontal displacement motor 38. Thanks to the motor 38 the tail pick up pulley 30 may be moved along its axis of symmetry. The bar 36 is movable along a bar 40 having a vertical position as shown in FIG. 2a. A vertical displacement motor 42 is arranged at one end of the bar 40 for moving the bar 36 along the bar 40. The bar 40 is attached to a fixing element 44 fixing the bar 40 to a turning shaft 46. The turning shaft 46 is journalled in bearings 48, 50, which are fixed to a beam structure 52, schematically indicated in FIG. 2b. An arm 54 is fixed to the shaft 46. A displacement motor 56 extends from one end of the arm 54 to a beam structure 58, schematically shown in FIGS. 2a and 2b. The displacement motor 56 is adapted to turn, by means of the shaft 46, the bar 40 from a vertical position, shown in FIG. 2a, to a tilted position, shown in FIG. 2b. A number of position indicators 59, shown in FIG. 2b, are provided for providing the process computer 19 with information on the positions of, among others, the bars 36, 40, the pulley 30 and the sleigh 22.

FIG. 2a further illustrates a slitting device in the form of a water jet knife 60. The water jet knife 60 is adapted for slitting the web 8 along its longitudinal direction upstream of the first roll 12 in order to form a tail, as will be described below. The device 18 further comprises a tail conveyor device 62 which is adapted to catch the tail and transfer it to the dryer 4. The tail conveyor device 62 comprises a tail conveyor bar 64 which is turnable in the horizontal plane by means of a joint 66. The joint 66 is attached to a beam structure, not shown in FIG. 2a, adjacent to the dryer 4. The tail conveyor device 62 comprises a threading belt 68 which runs over the tail conveyor device 62 into the dryer 4 and then back to the tail conveyor device 62 in an endless loop. The threading belt 68 is forwarded from the dryer 4 over two pulleys 70, 72, which are located at an end 74 of the bar 64, which end 74 is opposite to the joint 66. After the pulleys 70, 72 the threading belt 68 is led to a nip 76. The nip 76 is formed by the threading belt 68 and a belt 78, which is led over two pulleys 80, 82. When a tail is introduced into the nip 76 the belt 78 holds the tail against the threading belt 68 until the threading belt 68 is folded, in a per se known manner, around the tail, such that the tail, wrapped in the threading belt 68, may be forwarded, via a roll 84, to the dryer 4 in order to thread it. The tail conveyor device 62 further carries a tail cutting device 86. The tail cutting device 86, which is schematically illustrated in FIG. 2a, comprises a first blade 88 and a second blade 90, which is located close to the nip 76.

The way in which the device 18 for transferring a tail works will now be described in more detail.

In a first step (A), which is illustrated in FIG. 2a, FIG. 2c and FIG. 2d, the web 8 is forwarded from the wet forming station 2 over the first roll 12 by means of the press wire 6. The water jet knife 60 slits the web 8 and forms a tail 92, with a width W, illustrated in FIG. 2c and FIG. 2d, of about 100 mm. As described above the arrangement with the second roll 16, shown in FIG. 1, separates the web 8 from the wire 6 downstream of the first roll 12. Thus a gap 94, see FIG. 2a, is formed between the wire 6 and the tail 92 downstream of the first roll 12. In the situation shown in FIG. 2c the separating pin 20 is still located outside of the gap 94. By operating the air driven cylinder 28 the separating pin 20 may be inserted into the gap 94. This situation is best shown in FIG. 2d in which it is illustrated that the separating pin 20 extends under the entire width W of the tail 92.

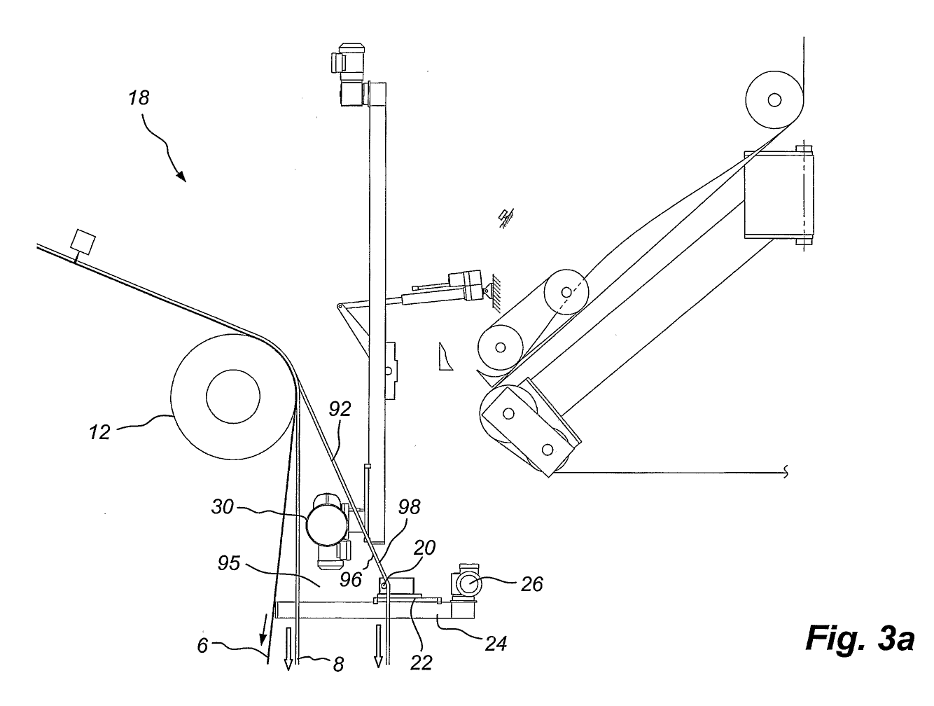

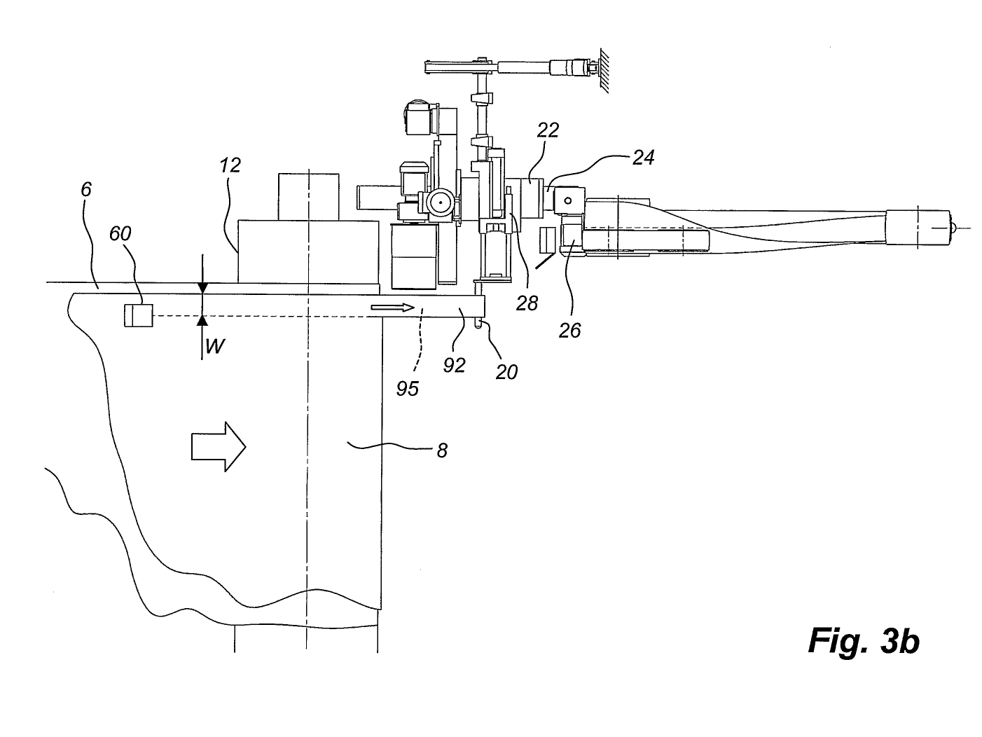

FIG. 3a and FIG. 3b illustrate a second step (B). In step (B) the motor 26 is operated to move the sleigh 22 horizontally along the bar 24 in a direction towards the dryer 4. Typically the sleigh 22 is moved a horizontal distance of about 200-800 mm. The tail 92 has a first face 96 facing the wet forming station 2 and a second face 98 facing the dryer 4. While moving the sleigh 22 the separating pin 20 will engage the first face 96 of the tail 92 and move the tail 92 towards the dryer, i.e. to the right as seen in FIGS. 3a and 3b. By moving the tail 92 the separating pin 20 separates the tail 92 further from the wire 6 and widens the gap 94 to form a space 95. FIGS. 3a and 3b illustrate the situation when a space 95 of sufficient width has been formed. Typically the space 95 has a width of 350-750 mm, at its widest point.

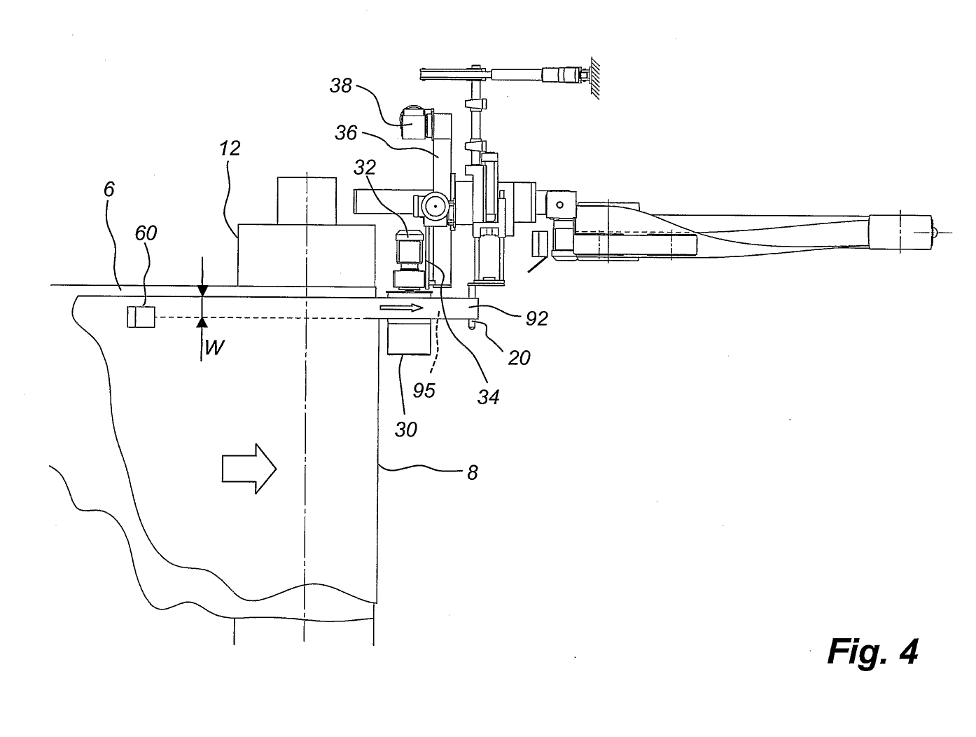

FIG. 4 illustrates a first part of a third step (C). In this first part the motor 38 moves the sleigh 34, and thus tail pick up pulley 30, horizontally along the bar 36 so that the tail pick up pulley 30 becomes inserted into the space 95, which has been formed by the separating pin 20 in step (B). The only difference between the situation in FIGS. 3a and 3b and the situation in FIG. 4 is thus that the tail pick up pulley 30 has been inserted, horizontally, into the space 95. It will be appreciated that a widening of the gap 94 to form the space 95 by means of the separating pin 20 in step (B) is a necessary measure for to provide a large enough space 95 for to receive the tail pick up pulley 30.

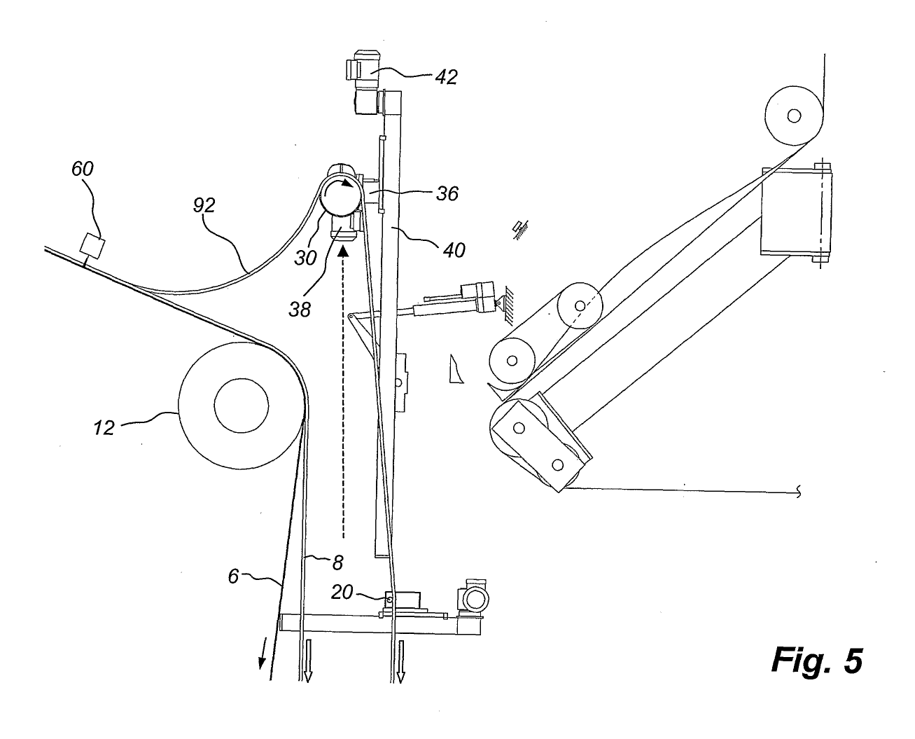

FIG. 5 illustrates a second part of the third step (C). In this second part the motor 42 has moved the bar 36, which carries the tail pick up pulley 30, vertically upwards along the vertical bar 40. The tail pick up pulley 30 has thus lifted the tail 92 vertically upwards to a position in which the highest point on the tail 92, i.e. at the tail pick up pulley 30, is located above the first roll 12. Starting at, or before, the lifting, and then continuously, the motor 32 rotates the pulley 30, clockwise as shown in FIG. 5, such that there are no excessive tensions built up in the tail 92 as it travels over the pulley 30. The motor 32 has a freewheeling function such that the tail pick up pulley 30 will not have a braking effect on the tail 92 in the event the tail 92 would travel quicker than what corresponds to the rpm of the motor 32 driving the tail pick up pulley 30.

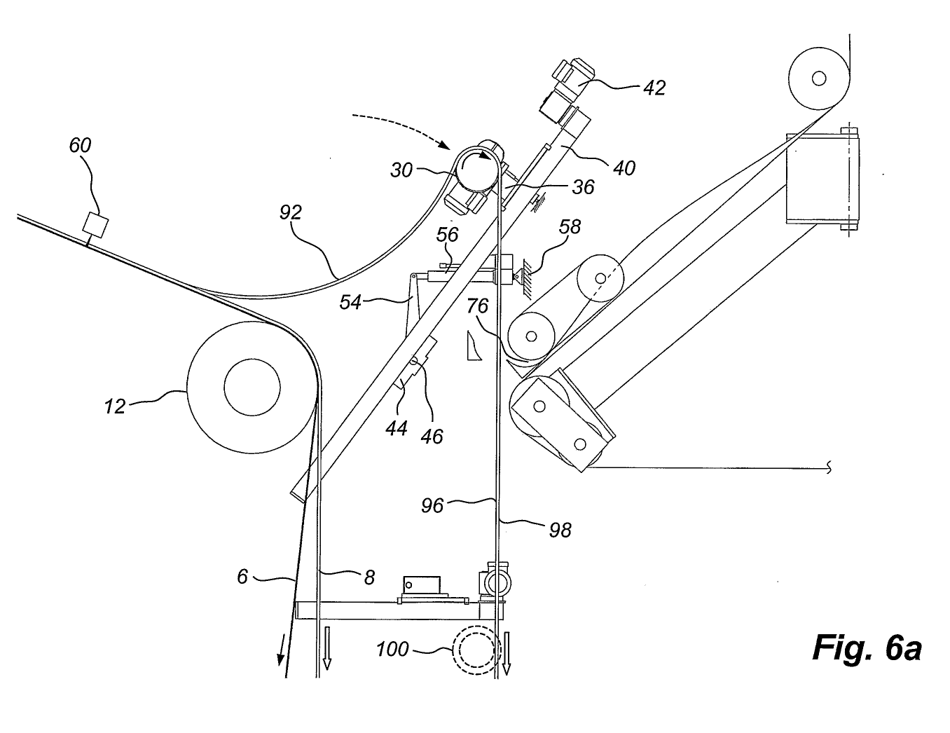

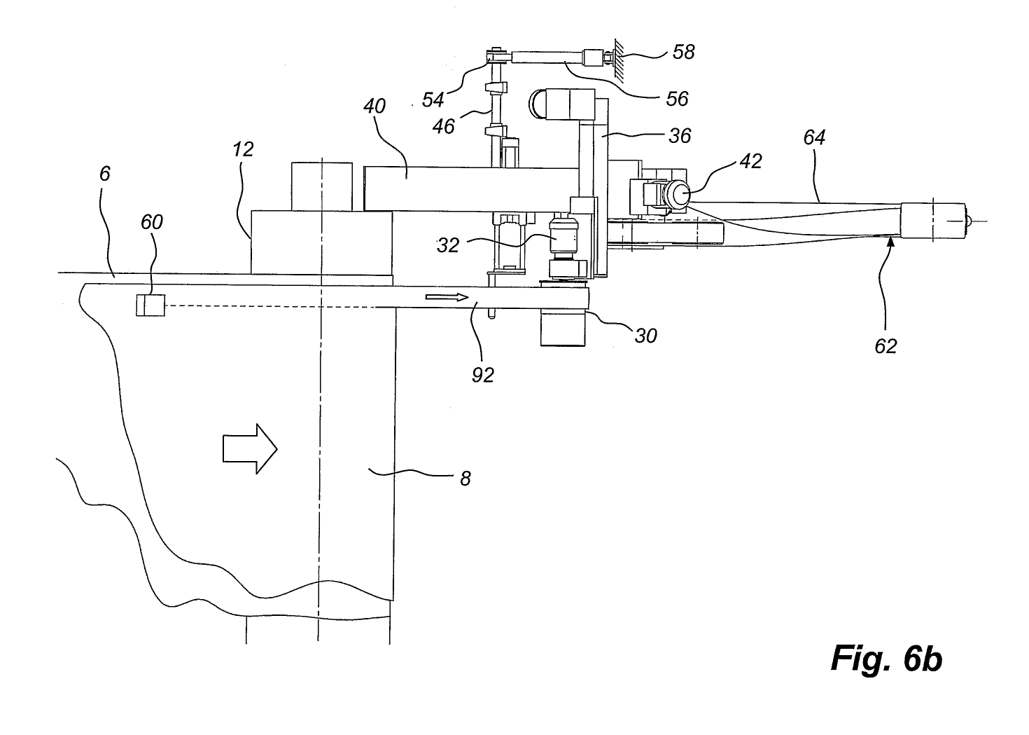

FIG. 6a and FIG. 6b illustrate a third part of the third step (C). In this third part the displacement motor 56 is retracted and actuates the arm 54 such that shaft 46 is turned clockwise, as shown in FIG. 6a. When the shaft 46 is turned the bar 40 is tilted, around the shaft 46, from a vertical to a tilted position. This makes the tail pick up pulley 30 move, along an arc of a circle indicated by a broken arrow in FIG. 6a, towards the dryer 4. As indicated by the broken arrow, the tilting of the bar 40 makes the pulley 30 move slightly downwards, thereby decreasing the tension in the tail 92 while tilting the bar 40. Thanks to this movement the tail 92 is moved into a cutting position located adjacent to the nip 76. Optionally a guiding device in the form of a guiding roll or a bobbin 100 could be provided substantially vertically below the pulley 30, and below the nip 76. The bobbin 100, which may be driven by a not shown motor, is made to contact one of the faces 96, 98, the first face 96 in the embodiment shown in FIG. 6a, such that any fluttering of the tail 92 downstream of the pulley 30 is avoided.

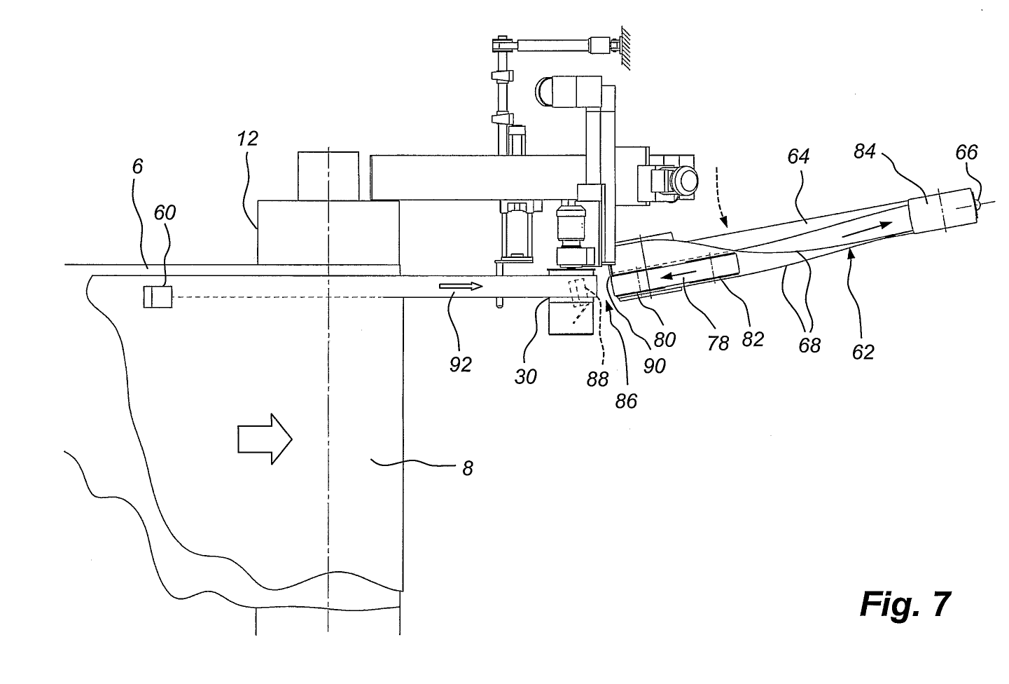

FIG. 7 illustrates a fourth and last part of the third step (C). In the fourth part the bar 64 of the tail conveyor device 62 has been turned, around the joint 66, as is indicated by a broken arrow in FIG. 7. Due to the turning the first blade 88, which is hidden by the pulley 30 in the perspective of FIG. 7, has become located adjacent to the first face 96 of the tail 92. The second blade 90 has become located adjacent to the second face 98 of the tail 92. The tail 92 is thus positioned between the blades 88, 90 and is in position for being cut by the tail cutting device 86.

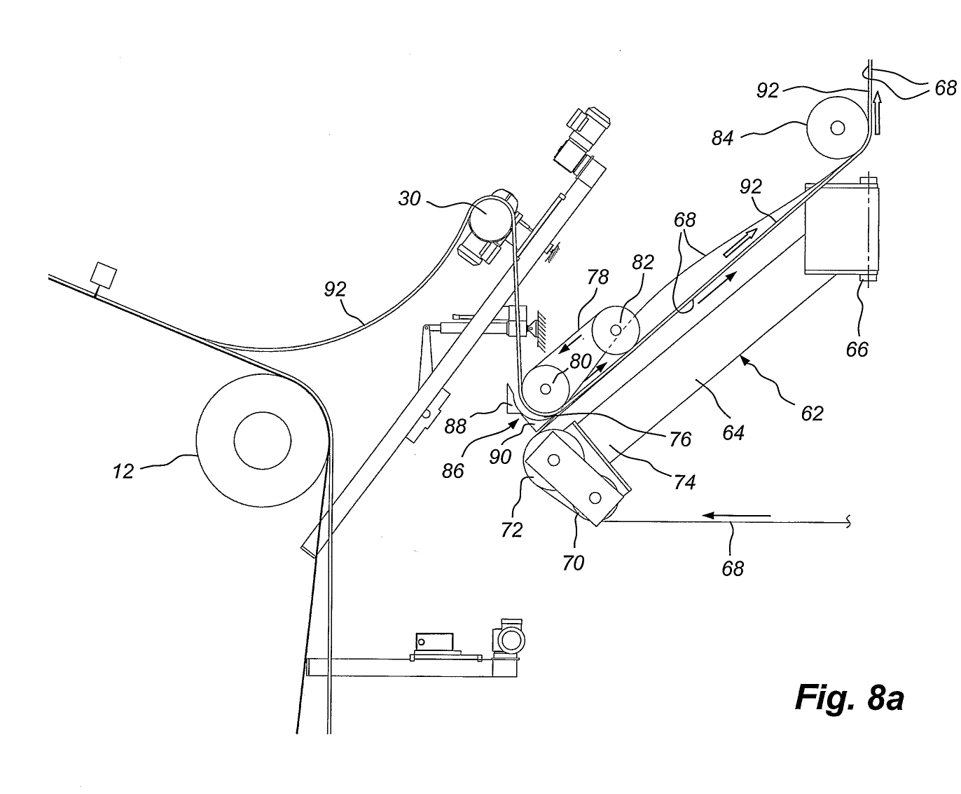

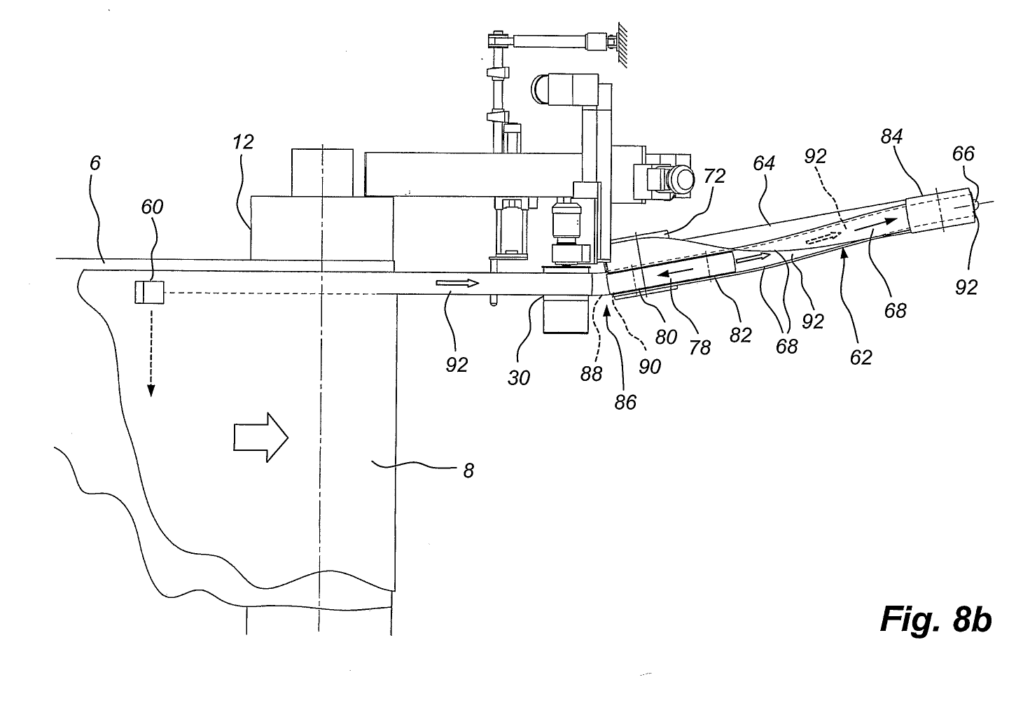

FIGS. 8a and 8b illustrate the situation just after the tail 92 has been cut, for example in a direction being perpendicular to the longitudinal direction of the tail, in a fourth step (D). The tail cutting device 86 has cut the tail 92 by means of rapidly moving the blade 88 towards the blade 90 and has simultaneously given the tail 92 an impulse in the direction of the nip 76. The impulse may be given in a similar manner as was described in WO 02/088463. The cut tail 92 has been captured between the threading belt 68 and the belt 78. According to per se known principles the threading belt 68 is folded, just after having passed the pulley 72 and the belt 78, around the cut tail 92, such that the cut tail 92 becomes enclosed in the threading belt 68, as is best shown in FIG. 8b. The threading belt 68 then forwards the tail 92 along the bar 64, around the roll 84 and further into the dryer. As soon as the threading belt 68 has transferred the enclosed tail 92 a sufficient distance, typically 25 meters, into the dryer the bar 64 of the tail conveyor device 62 is returned to its starting position, i.e. the position indicated in FIG. 6b, thereby releasing the tail 92 which may then travel on its own through the dryer. The width of the tail 92 is gradually increased by moving the water jet knife 60 downwards in the perspective of FIG. 8b, also indicated by means of a broken arrow, until the tail 92 receives the full width of the web 8. When the web 8 travels in its full width from the wet forming station 2 to the dryer 4 the threading of the dryer is completed. The separating pin 20, the tail pick up pulley 30 and the tail conveyor device 62 may all be returned to their starting positions, i.e. the positions shown in FIGS. 2a and 2c.

It will be appreciated that the steps (A) to (D) illustrated in FIG. 2a to FIG. 8b are preferably automatically controlled by the process computer 19, shown in FIG. 1. When the process computer 19 receives input from a sensor, not shown, that the web 8 has broken, either in a position between the wet forming station 2 and the dryer 4 or inside the dryer 4 itself, it automatically controls the device 18 to perform the steps (A) to (D) and thus to automatically transfer a tail from the wet forming station 2 to the dryer 4, and to thread the dryer 4. The process computer 19 thus automatically controls every step of transferring the tail 92 without any manual interference. Often it is required, however, to manually check that the dryer is free of any obstructing elements before initiating the threading. Once an operator has checked that the dryer is ready he may order, e.g. by pressing a start button, the process computer 19 to automatically perform the steps (A) to (D).

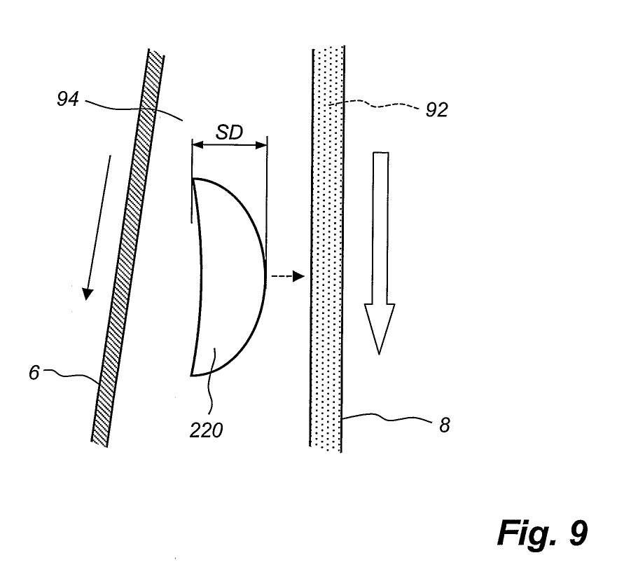

FIG. 9 illustrates an alternative embodiment of a separating member in the form of a separating member 220. As can be seen from FIG. 9 the separating member 220 has the shape of a half-moon and has a smallest dimension SD, as seen from above, which is 10-80 mm. The separating member 220 is therefore thin enough to be inserted into the gap 94 formed between the web 8 and the press wire 6. By moving the separating member 220 horizontally, as indicated by a broken arrow, towards the web 8 it is possible to separate and move a tail 92, hidden in FIG. 9, towards a second treatment unit to form a space of sufficient width. In this process the tail will slide over the gentle contour of the separating member 220. Thus a separating member which is useful in the present invention need not be cylindrical, as long as the separating member has a gentle contour over which the first face of the tail may slide.

It will be appreciated that numerous variants of the above described embodiments are possible within the scope of the appended claims.

For instance the separating member need not be cylindrical or half-moon shaped. The separating member may also have the shape of a deflecting plate or wedge which can be inserted in the gap and be used for moving the tail away from the first treatment unit.

The water jet knife 60 is in FIG. 2c, among other Figs., shown as located just upstream of the first roll 12. However, the water jet knife may, for instance, be located at another position in the wet forming station 2, for instance at the, not shown, forming wire. The exact location of the water jet knife is not critical, as long as a tail is formed upstream of the location where the tail is to be forwarded to the dryer.

As mentioned above it is preferable to have a process computer 19 automatically controlling the steps (A) to (D). It is, however, also possible to manually control each of the steps (A) to (D), e.g. from a control panel. While the later is more time consuming and usually slower, it may in some cases be preferable to a completely automatic operation.

Above it is described, with reference to FIG. 1, that the first roll 12 has a larger diameter than the second roll 16 in order to move, downstream of the first roll 12, the press wire 6 in the direction of the wet forming station 2, resulting in the separation of the web 8 from the wire 6. It will be appreciated that there are alternative ways of obtaining this separation. For instance it is possible to provide first and second rolls of the same diameter, but to locate the centre line of the second roll closer to the wet forming station compared to the centre line of the first roll.

As described above the tail pick up pulley 30 may first move the tail vertically, as illustrated in FIG. 5, and then move the tail horizontally, as indicated in FIG. 6a. It will be appreciated that it is in principle also possible to first move the tail horizontally and then vertically or to move the tail both vertically and horizontally at the same time.

While it has been described above that the separating pin moves the tail away from the first treatment unit in order to form a space between the press wire and the tail it will be appreciated that other alternatives are also possible. It is, for instance, possible to instead have a separating member contacting the press wire downstream of the first roll. The separating member may then move the press wire, not the tail, in the direction of the first treatment unit in order to form a space between the press wire and the tail.

It has been described how the device and the method of the present invention is used for transferring a tail from a first treatment unit in the form of a wet forming station to a second treatment unit in the form of a dryer. It will be appreciated that it is also possible to use the present invention for transferring a tail between other types of first and second treatment units. For instance the invention could be used for transferring a tail between a first stage and a second stage inside the wet forming station, between a first and a second stage of the dryer or between the dryer and a web packing station.

It has been described above that the inclination α between the press wire 6 and the vertical plane may be 7°, see FIG. 1. The inclination α is preferably at least 4°. An inclination α of less than 4° makes it difficult to obtain the gap 94 and thus it may become difficult to insert the separating member. For practical reasons, increased space requirement etc., an inclination α of more than 20° is seldom suitable.

According to a further embodiment it is also possible to force a separating member in between the tail and the press wire, also in the absence of a gap between the press wire and the tail. In such a case the separating member may advantageously be provided with a point at its end so as to make it easier for the separating member to find the way between the tail and the wire. It is also possible to design the separating member in such a way that it, when it is about to be forced between the press wire and tail, first contacts the press wire and slides against the press wire until the separating member is located between the press wire and the tail.

In FIG. 5 and FIG. 6a it is shown how the tail is moved first vertically, i.e in the y-direction, and then horizontally, i.e. in the x-direction, into position. It is also possible, according to an alternative embodiment, to move the tail also in the z-direction. With reference to FIG. 6b the tail would then be moved upwards, for example by moving the motor 32, together with the tail pick up pulley 30, upwards along the bar 36. The advantage of moving the tail also in the z-direction, i.e. upwards as seen in the perspective of FIG. 6b, is that the tail conveyor device 62 need not be turned about the joint 66, as illustrated in FIG. 7, but may remain in position. Thus the tail pick up pulley 30 would, according to this alternative embodiment, move the tail 92 into the cutting position, by moving the tail 92 in the x-, y- and z-directions, not necessitating any movement of the tail conveyor device 62.

According to FIG. 6a a guiding device in the form of a bobbin 100 is used for guiding the tail 92 during the cutting. It will be appreciated that a guiding device of another design may also be used. For instance a guiding device could be formed from two parallel fixed guiding plates that are held, by means of a central portion, at a distance from each other, the distance corresponding to the width of the tail. The guiding plates and the central portion need not be rotatable, since the friction between the tail and the guiding plates, and the central portion, could be made quite low, for instance by forming the guiding plates and the central portion from steel plate.

The guiding device may be arranged on the tail conveyor device 62. Thereby the guiding device, such as the bobbin 100, is turned into position together with the tail conveyor device 62, when the tail conveyor device 62 is turned into position, as shown in FIG. 7. The sequence could be made in two steps; first the tail conveyor device is turned, together with the guiding device, e.g. the bobbin 100, into the correct turning position, and then the guiding device, e.g. the bobbin 100, is moved into contact with the tail.

1. A method of transferring a tail of a cellulose based fibrous web from a first treatment unit to a second treatment unit, the method comprising:
(A) forwarding the web from the first treatment unit, allowing the web to travel substantially vertically downwards from a first roll, and slitting the web along a longitudinal direction of the web to form a tail having a first face facing the first treatment unit and a second face facing the second treatment unit,
(B) forming, by separating member, a space between the first face of the tail and the first treatment unit,
(C) inserting a tail pick up pulley in said space between the first face of the tail and the first treatment unit, and moving, by use of the tail pick up pulley, the tail into a cutting position, and
(D) cutting the tail, and catching the tail by means of a tail conveyor device for forwarding the tail to the second treatment unit.

2. The method according to claim 1, wherein step (B) further comprises engaging the separating member with the first face of the tail and moving the tail, by means of the separating member, towards the second treatment unit.

3. The method according claim 1, wherein step (A) further comprises forwarding the web on a wire, the wire being moved away from the first face of the tail downstream of said first roll such that a gap is formed between the wire and the tail, and step (B) further comprises providing the separating member in said gap and widening said gap to form said space.

4. The method according to claim 1, wherein step (C) further comprises moving the tail pick up pulley both vertically upwards and horizontally towards the second treatment unit when moving the tail into the cutting position.

5. The method according to claim 1, wherein step (B) further comprises moving the separating member in a horizontal direction while forming said space.

6. The method according to claim 5, wherein step (B) further comprises moving the separating member horizontally a distance of 200-800 mm while forming said space.

7. A device for transferring a tail of a cellulose based fibrous web from a first treatment unit to a second treatment unit, the tail being formed by forwarding the web from the first treatment unit, allowing the web to travel substantially vertically downwards from a first roll, and slitting the web along its longitudinal direction to form a tail having a first face facing the first treatment unit and a second face facing the second treatment unit,
wherein the device comprises:
a separating member, which is adapted to form a space between the first face of the tail and the first treatment unit,
a tail pick up pulley which is adapted to be inserted in said space between the first face of the tail and the first treatment unit, the tail pick up pulley further being adapted for moving the tail into a cutting position,
a tail cutting device being adapted for cutting the tail at said cutting position, and
a tail conveyor device being adapted for catching the tail cut at the cutting position, and for forwarding the cut tail to the second treatment unit.

8. The device according to claim 7, wherein the separating member is adapted to be inserted in a gap formed between the first face of the tail and a wire by which the web is forwarded, the gap being formed downstream of said first roll by the wire being moved away from the first face of the tail.

9. The device according to claim 7, wherein the tail pick up pulley has a diameter (D) of 120-400 mm, and a motor being adapted for rotating the pulley.

10. The device according to claim 7, a guiding device being adapted for being located below the tail pick up pulley, when the tail is at the cutting position, in order to stabilize the tail when the tail cutting device cuts the tail 9.

11. The device according to claim 7, wherein the separating member has a smallest dimension which is 10 mm to −80 mm.
